(19) United States
(12) Patent Application Publication
(10) Pub. No.: US 2018/0039516 A1
(43) Pub. Date: Feb. 8, 2018

(54) HETEROGENEOUS AUTO-SCALING USING HOMOGENEOUS AUTO-SCALING GROUPS

(71) Applicant: International Business Machines Corporation, Armonk, NY (US)

(72) Inventors: Ofer Biran, Haifa (IL); Dean Lorenz, Haifa (IL); Eran Raichstein, Yokneam IIit (IL); Avi Weit, Haifa (IL)

(21) Appl. No.: 15/230,512

(22) Filed: Aug. 8, 2016

(51) Int. Cl. G06F 9/50; G06F 9/445

(52) U.S. Cl. CPC G06F 9/5005; G06F 9/44505

(57) ABSTRACT

Methods, computing systems and computer program products implement embodiments of the present invention that include defining, for a request processing system, a first homogeneous auto-scaling group including a first monitored resource, a first set of processing systems, a first minimum threshold, a first maximum threshold, and a first system configuration. Subsequent to defining the first homogeneous auto-scaling group, a second auto-scaling group is defined for the request processing system, the second auto-scaling group including a second monitored resource different from the first monitored resource, a second set of processing systems, a second minimum threshold, a second maximum threshold, and a second system configuration different from the first system configuration. In embodiments of the present invention, a load balancer for the request processing system manages the first and the second sets of processing systems as a single heterogeneous auto-scaling group.

### FIELD OF THE INVENTION

The present invention relates generally to computer resource management, and specifically to auto-scaling computer resources.

### BACKGROUND

One key feature of cloud computing is an ability to dynamically scale computing resources in order to match demand. This dynamic scaling is commonly referred to as auto-scaling, and enables a pay-per-use model where customers pay a cloud provider according to their actual resource usage, and the customers are provided with the necessary scalability for times of peak demand. In some cloud-based systems, the entity of auto-scaling is a virtual machine. The customer can define an auto-scaling group, specify its minimum and maximum size (e.g., number of virtual machines), and define policies for auto-scaling actions such as increasing or decreasing the number of virtual machines in the auto-scaling group upon crossing a specified average processor utilization threshold.

The configurations of virtual machines in an auto-scaling group are typically specified by a predefined template, and if all the virtual machines of the auto-scaling group are created according to the configuration specified in the template, the auto-scaling group can be referred to as a homogeneous auto-scaling group. In operation, auto-scaling groups can be fronted by a load balancer that distributes incoming requests (e.g., HTTP requests for Web servers, database transactions for database servers etc.) among virtual machines in the auto-scaling group.

The description above is presented as a general overview of related art in this field and should not be construed as an admission that any of the information it contains constitutes prior art against the present patent application.

### SUMMARY

There is provided, in accordance with an embodiment of the present invention a method, including defining, for a request processing system, a first homogeneous auto-scaling group including a first monitored resource, a first set of processing systems, a first minimum threshold, a first maximum threshold, and a first system configuration, defining, for the request processing system, a second homogeneous auto-scaling group including a second monitored resource different from the first monitored resource, a second set of processing systems, a second minimum threshold, a second maximum threshold, and a second system configuration different from the first system configuration, and managing, by a load balancer for the request processing system, the first and the second sets of processing systems.

There is also provided, in accordance with an embodiment of the present invention an apparatus, including a memory, and a processor configured to define, in the memory, a first homogeneous auto-scaling group including a first monitored resource, a first set of processing systems, a first minimum threshold, a first maximum threshold, and a first system configuration, to define, in the memory, a second homogeneous auto-scaling group including a second monitored resource different from the first monitored resource, a second minimum threshold, a second set of processing systems, a second maximum threshold, and a second system configuration different from the first system configuration, and to manage the first and the second sets of processing systems.

There is further provided, in accordance with an embodiment of the present invention a computer program product, the computer program product including a non-transitory computer readable storage medium having computer readable program code embodied therewith, the computer readable program code including computer readable program code configured to define, for a request processing system, a first homogeneous auto-scaling group including a first monitored resource, a first set of processing systems, a first minimum threshold, a first maximum threshold, and a first system configuration, computer readable program code configured to define, for the request processing system, a second homogeneous auto-scaling group including a second monitored resource different from the first monitored resource, a second set of processing systems, a second minimum threshold, a second maximum threshold, and a second system configuration different from the first system configuration, and computer readable program code configured to manage, by a load balancer for the request processing system, the first and the second sets of processing systems.

### BRIEF DESCRIPTION OF THE DRAWINGS

The disclosure is herein described, by way of example only, with reference to the accompanying drawings, wherein:

FIG. 1 is a block diagram that schematically illustrates a computer facility configured to manage a heterogeneous auto-scaling group comprising multiple homogeneous auto-scaling groups, in accordance with an embodiment of the present invention;

FIG. 2 is a flow diagram that schematically illustrates a method of managing the heterogeneous auto-scaling group, in accordance with an embodiment of the preset invention; and

FIGS. 3-6 are block diagrams that schematically illustrate a scheduler distributing requests to virtual machines in the heterogeneous auto-scaling group, in accordance with an embodiment of the preset invention.

### DETAILED DESCRIPTION OF EMBODIMENTS

While a single static template is typically used to configure identical homogeneous virtual machines in a homogenous auto-scaling group (ASG), characteristics of requests serviced by the virtual machines may be dynamic and can change over time. Therefore, there may be instances when resources in the template's virtual machine configuration no longer match resources required by received requests. For example, virtual machines can be configured to process processor-intensive requests and to auto-scale according to demand. If these virtual machines start receiving (e.g., due to some external event) requests that comprise memory-intensive operations, auto-scaling these virtual machines (i.e., using the template that was designed for processor-intensive requests) can result in unnecessary processor resources being assigned to these virtual machines.

Embodiments of the present invention provide methods and systems for creating, for a request processing system, a heterogeneous auto-scaling group comprising multiple homogeneous auto-scaling groups. As described hereinbelow, a first homogeneous auto-scaling group and a second auto-scaling group are defined. The first homogeneous auto-scaling group comprises a first monitored resource, a first set of processing systems, a first minimum threshold, a first maximum threshold, and a first system configuration, and the second homogeneous auto-scaling group comprises a second monitored resource different from the first monitored resource, a second set of processing systems, a second minimum threshold, a second maximum threshold, and a second system configuration different from the first system configuration. For example, the first monitored resource may comprise processor resources, and the second monitored resource may comprise memory resources.

In embodiments of the present invention, the homogeneous auto-scaling groups comprise a single heterogeneous auto-scaling group, and a load balancer for the request processing system manages the first and the second sets of processing systems by receiving a request and conveying the request to a given processing systems in the first and the second sets. By managing the first and the second sets of processing systems (i.e., as a single combined set), the load balancer can ensure that the resources of processing systems (e.g., virtual machines) managed by the load balancer are used efficiently.

In operation, attributes of the auto-scaled resources can be continuously matched to attributes of the current demand (i.e., of requests being processed), thereby optimizing resource usages over multiple dimensions. In some embodiments, the optimal resource “flavor” for each auto-scaling action can be selected without modifying the existing cloud auto-scaling mechanism. Therefore, systems implementing embodiments of the present invention can minimize cost while still meeting service level agreements, and can adapt to demand changes in terms of volume and in terms of any changes (i.e., in received requests) that require different scaling for different resource dimensions.

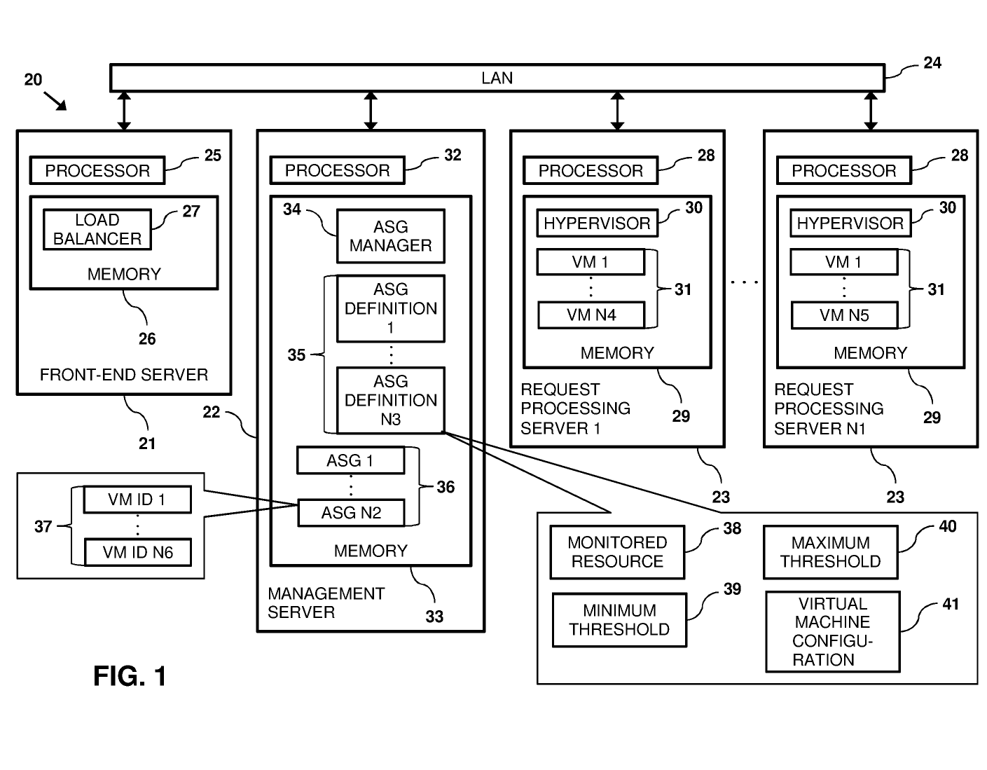

FIG. 1 is a block diagram that schematically illustrates a computer facility 20 comprising a front-end server 21, a management server 22 and one or more request processing servers 23 that all communicate over a local area network (LAN) 24. While the configuration in FIG. 1 shows servers 21, 22 and 23 communicating over LAN 24, configuring the servers to communicate over any other type of communications network is considered to be within the spirit and scope of the present invention.

Front-end server 21 comprises a front-end processor 25, and a front-end memory 26. In operation, processor 25 executes a load balancer 27 from memory 26. The functionality of load balancer 27 is described hereinbelow.

Each request processing server 23 comprises a request processor 28 and a request memory 29 that stores a set of processing systems, each of the processing systems configured to execute a software application that processes requests. In some embodiments, as shown in FIG. 1, the processing systems comprise one or more virtual machines (VMs) 31 that are managed by a hypervisor 30. In operation, each processor 28 executes, from a given memory 29, a given hypervisor 30 that manages the virtual machines in the given request memory. Other types of processing systems that can be used to implement embodiments of the present invention are described hereinbelow.

Management server 22 comprises a management processor 32 and a management memory 33. Memory 33 stores an auto-scaling group (ASG) manager 34, multiple auto-scaling group definitions 35, and a plurality of auto-scaling groups 36. Each auto-scaling group 36 comprises one or more virtual machine identifiers (IDs) 37, wherein each of the virtual machine identifiers references a unique virtual machine 31. In operation, the virtual machines for a given auto-scaling groups 36 may be distributed among multiple servers 23. Each auto-scaling group definition 35 comprises a monitored resource 38, a minimum threshold 39 (also referred to herein as a low threshold), a maximum threshold 40 (also referred to herein as a high threshold) and a virtual machine configuration 41 (also referred to herein as a system configuration).

In an alternative configuration, the functionalities of front-end server 21 and management server 22 can be combined into a single computer system. For example, processor 32 can execute load balancer 27 from memory 33. Additionally, there may be one or more host computers coupled to servers 21, 22 and 23 that execute a cloud management software application that interact with the servers (e.g. requesting the hypervisor on a given server 23 to create an additional virtual machine 31). In some embodiments, the cloud management software application can perform operations such as maintaining auto-scaling group definitions 35, monitoring the auto-scaling groups, and managing the auto-scaling groups operations (e.g., adding a new virtual machine 31 to a given auto-scaling group 36 or deleting a given virtual machine 31 from a given auto-scaling group 36). In configurations comprising a cluster of multiple servers 23, adding a new virtual machine 31 to a given auto-scaling group 36 may comprise selecting a given request processing server 23 that will execute the new virtual machine.

In each auto-scaling group definition 2:
Monitored resource 38 comprises a system resource in a given server 23 that auto-scaling group manager 34 monitors in order to add or remove a given virtual machine 31. Examples of the system resources that auto-scaling group manager 34 can monitor include, but are not limited to, utilization of a given processor 28 (also referred to herein as processor utilization), utilization of a given memory 29 (also referred to herein as memory utilization) and input/output (I/O) utilization (e.g., I/O utilization of networking or storage resources).
Each virtual machine configuration 41 comprises a configuration of system resources that hypervisors 30 can use to define one or more virtual machines 31. Examples of system resources included in virtual machine configuration 41 include processor resources, memory resources, storage resources, storage adapter resources and network adapter resources.
Each minimum threshold 39 comprises a utilization level for a given monitored resource 38. In embodiments of the present invention, auto-scaling manager 24 instructs a given hypervisor 30 to delete a given virtual machine 31 if the utilization level for the monitored resource (e.g., averaged over the virtual machines in a given auto-scaling group 36) falls below the minimum threshold. For example, if the monitored resources comprises processor resources and the minimum threshold is 5%, then auto-scaling manager 34 instructs a given hypervisor 30 to delete a given virtual machine 31 if the utilization level for the monitored processor falls below 5%.
Each maximum threshold 40 comprises a utilization level for a given monitored resource 38. In embodiments of the present invention, auto-scaling manager 34 instructs a given hypervisor 30 to deploy an additional virtual machine 31 if all the utilization levels for the monitored resource of the virtual machines in a given auto-scaling group 36 exceed the maximum threshold. For example, in a given auto-scaling group 36, if the monitored resources comprises memory resources and the maximum threshold is 90%, then auto-scaling manager 34 instructs a given hypervisor 30 to deploy an additional virtual machine 31 if the utilization levels of the memory resources for the virtual machines in the given auto-scaling group exceed 90%.

In operation, hypervisor 30 manages virtual machines 31. In embodiments of the present invention, upon receiving, from auto-scaling manager 34, a request to use a given virtual machine configuration 41 to create a given virtual machine 31, hypervisor 30 creates the given virtual machine. Likewise, upon receiving, from auto-scaling manager 34, a request to delete a given virtual machine 31, hypervisor 30 can delete the given virtual machine.

Auto-scaling groups 36 are considered to be homogeneous since all of the virtual machines in a given auto-scaling group 36 (and the virtual machines that might be added by auto-scaling operations) are identical, since they are based on the same configuration 41 (i.e., a template) in a given auto-scaling group definition 35. Therefore, auto-scaling groups 36 may also be referred to herein as homogeneous auto-scaling groups 36. In embodiments of the present invention, two or more homogeneous auto-scaling groups 36 can be combined to form a heterogeneous auto-scaling group, and load balancer 27 can be configured to assign requests to virtual machines 40 in order to balance the load of the virtual machines in the heterogeneous auto-scaling group.

While the example in FIG. 1 shows a single auto-scaling group manager 34, other configurations are considered to be within the spirit and scope of the present invention. For example, an alternative configuration may comprise each auto-scaling group 36 having its own respective auto-scaling group manager 34. Additionally, while embodiments herein describe auto-scaling group manager 34 managing the creation and deletion of processing systems comprising virtual machines 31 in auto-scaling groups 36, configuring the auto-scaling group manager to create and delete other types of processing systems in the auto-scaling groups is considered to be within the spirit and scope of the present invention.

For example, auto-scaling group manager 34 can be configured to manage the creation and deletion of processing systems such as physical computing systems and software containers. In embodiments where the processing systems comprise physical computing systems, the system configurations in auto-scaling groups definitions 35 comprise physical computing system configurations (not shown) that auto-scaling group manager 36 can use to configure the physical computing systems. Likewise, in embodiments where the processing systems comprise software containers, processors 22 28, from memory 29, a software container engine (not shown) that manages (i.e., crates and deletes) the software containers, and the system configurations in auto-scaling group definitions 35 comprise software container configurations (not shown) that auto-scaling group manager 34 can use to configure the software containers.

In some embodiments, each of the processing systems (e.g., virtual machines 31) can be configured to convey the utilizations of their respective monitored resources (i.e. for their respective auto-scaling groups 36) to load balancer 27, and the load balancer can incorporate these utilizations when assigning a request to a given virtual machine 31.

Processors 25, 28 and 32 comprise general-purpose central processing units (CPU) or special-purpose embedded processors, which are programmed in software or firmware to carry out the functions described herein. The software may be downloaded to servers 21, 22 and 23 in electronic form, over a network, for example, or it may be provided on non-transitory tangible media, such as optical, magnetic or electronic memory media. Alternatively, some or all of the functions of processors 21, 22 and 23 may be carried out by dedicated or programmable digital hardware components, or using a combination of hardware and software elements. Examples of memories 26, 29, and 33 include dynamic random-access memories and non-volatile random-access memories.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

### Heterogeneous Auto-Scaling Group Management

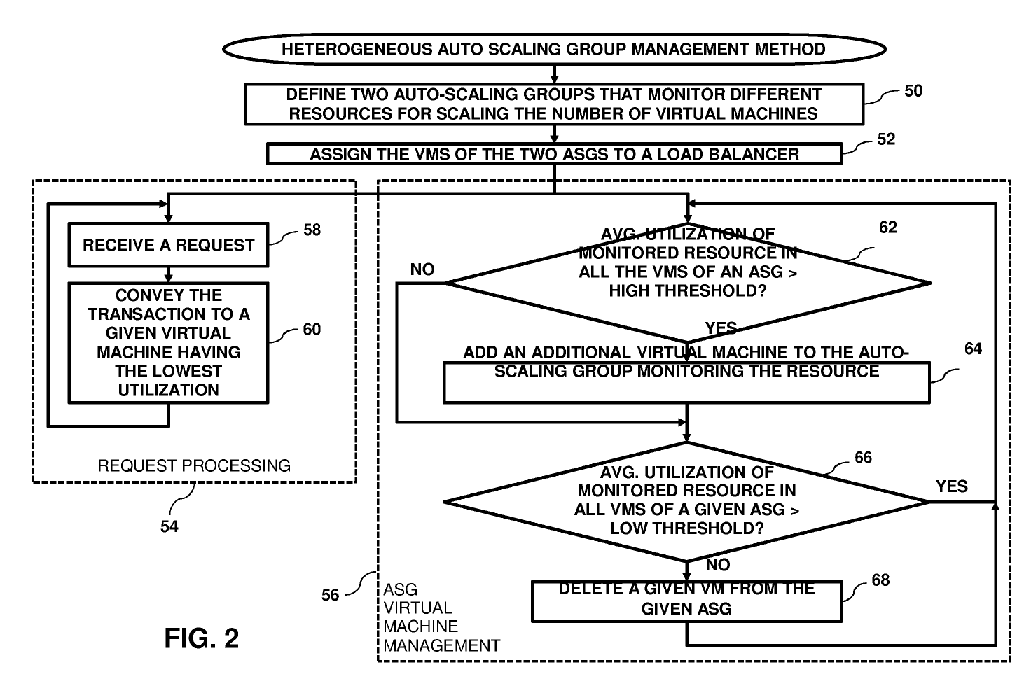

FIG. 2 is a flow diagram that schematically illustrates a method of implementing a heterogeneous auto-scaling group (ASG) comprising two or more homogeneous auto-scaling groups 36, in accordance with an embodiment of the present invention. In a definition step 50, auto-scaling group manager 34 defines two auto-scaling groups 36. Each given auto-scaling group 36 comprises a different monitored resource 38 which auto-scaling group manager 34 monitors in order to scale (i.e., either increase or decrease) the number of virtual machines 31 in the given auto-scaling group.

In an assignment step 52, auto-scaling group manager 34 assigns the virtual machines (VMs) of the two defined homogeneous auto-scaling groups (ASGs) 36 to load balancer 27. In embodiments of the present invention, load balancer 27 manages the virtual machines in the two homogeneous auto-scaling groups 36 as a single set of virtual machines 31. To define the homogeneous auto-scaling groups and assign the virtual machines, auto-scaling group manager can receive input from a user (not shown) or retrieve a configuration file that stores the definitions and assignment.

Upon completing steps 50 and 52, load balancer 27 executes a request processing thread 54 comprising steps 58 and 60, and auto-scaling manager 34 simultaneously executes a virtual machine management thread 56 comprising steps 62-68.

In a receive step 58, load balancer 27 receives a request, and in a convey step 60, the load balancer identifies given virtual machine 31 (i.e., in the heterogeneous auto-scaling group comprising the two homogeneous auto-scaling groups 36) that is able to handle the request and has the most available resources (e.g., processor and memory), conveys the received request to the identified virtual machine, and the method continues with step 58. Upon receiving the request conveyed by load manager 27, the identified virtual machine processes the request. An example of a request comprises a customer's order for an item sold by an online retailer.

In a first comparison step 62, if auto-scaling group manager 34 detects that the average (AVG) utilization of the monitored resources of the virtual machines in a given homogeneous auto-scaling group 36 exceed the maximum threshold for the given auto-scaling group, then in an addition step 64, the auto-scaling group manager instructs a given hypervisor 30 to create and deploy an additional virtual machine 36 (i.e., using the virtual machine configuration for the given auto-scaling group), and notifies load balancer 27 as to the availability of the additional virtual machine.

In a second comparison step 66, if auto-scaling group manager 34 detects that the average utilization of the monitored resource for all the virtual machines in a given auto-scaling group 36 is greater than the minimum threshold for the given auto-scaling group, then the method continues with step 62. However, if the average utilization of the monitored resource for all the virtual machines in a given auto-scaling group 36 is not greater than the minimum threshold for the given auto-scaling group, then in a deletion step 68 the auto-scaling group manager instructs hypervisor 30 to delete a given virtual machine 31 from the given auto-scaling group, and the method continues with step 64. Upon notifying hypervisor 30 to release the given virtual machine, scaling group manager 34 notifies load balancer 27 that the given virtual machine is no longer available.

Returning to step 62, if auto-scaling group manager 34 detects that all the virtual machines in all the auto-scaling groups have average utilizations of their respective monitored resources 38 that are below their respective maximum thresholds 40, then the method continues with step 66.

While the flow diagram shown in FIG. 2 describes combining two homogeneous auto-scaling groups 36 to form a heterogeneous auto-scaling group, combining more than two homogeneous auto-scaling groups 36 to form a heterogeneous auto-scaling group is considered to be within the spirit and scope of the present invention.

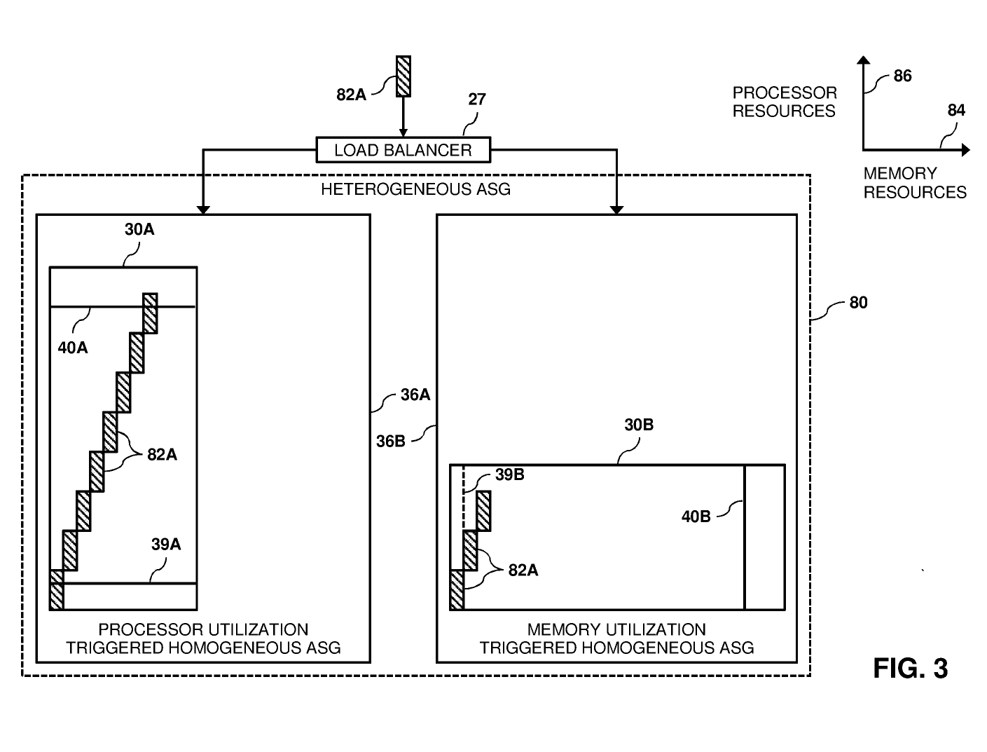

FIGS. 3-6 are block diagrams that schematically a heterogeneous auto-scaling group 80 comprising two homogeneous auto-scaling groups 36 processing requests 82 distributed by load balancer 27, in accordance with an embodiment of the preset invention. In FIGS. 3-6 homogeneous auto-scaling groups 36, virtual machines 31 and requests 82 their respective components are differentiated by appending a letter to the identifying numeral, so that the homogeneous auto-scaling groups comprise homogeneous auto-scaling groups 36A and 36B, the virtual machines comprise virtual machines 31A-31D and the requests comprise requests 82A and 82B.

In the examples presented in FIGS. 3-6, the different configurations of virtual machines 31 and requests 82 are presented with reference to a generally horizontal axis 84 that represents memory resources and a generally vertical axis 86 that represents processor resources. As shown in the Figures, requests 82A comprise processor intensive tasks, and requests 82B comprise memory intensive tasks. Examples of processor intensive requests 82A include compression/decompression requests and video encoding requests, and examples of memory intensive requests 82B include database requests and high resolution image processing requests.

Virtual machines 31A and 31C have a high ratio of processor resources to memory resources, and are therefore optimized for handling processor intensive requests 82A, and virtual machines 31B and 31D have a high ratio of memory resources to processor resources, and are therefore optimized for handling memory intensive requests 82B. In FIGS. 3-6, auto-scaling groups 36A and 36C are referred to as processor utilization triggered auto-scaling groups and auto-scaling groups 36B and 36D are referred to as memory utilization triggered auto-scaling groups.

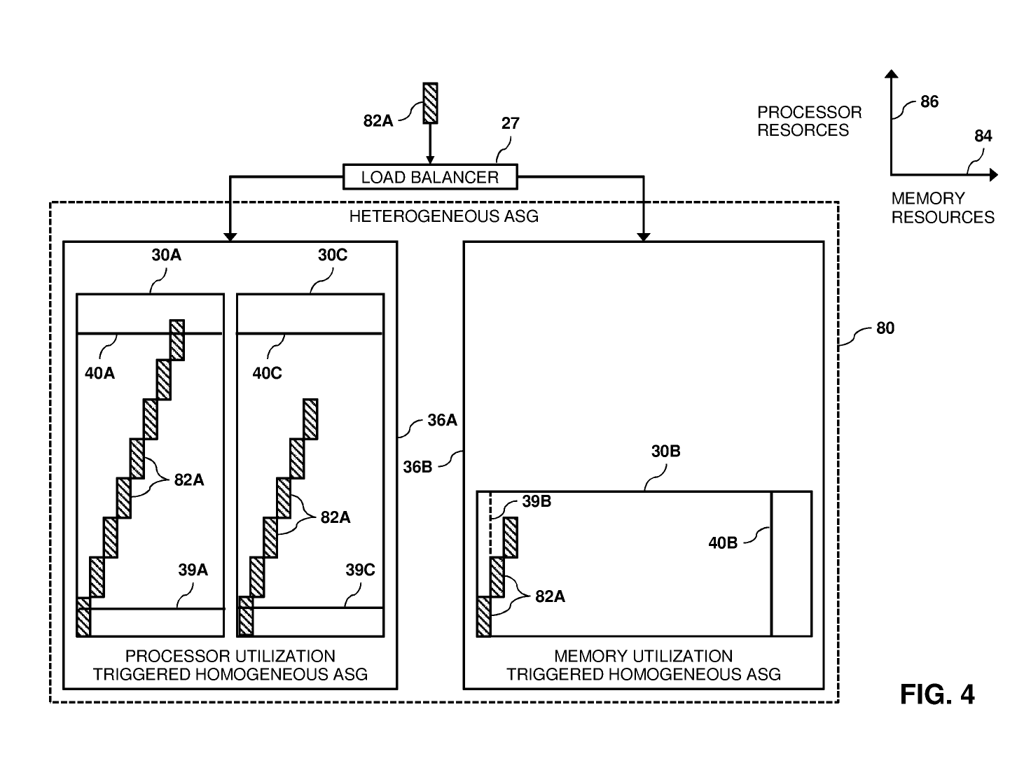

In FIG. 3, heterogeneous auto-scaling group 80 is processing a series of requests 82A in virtual machines 31A and 31B, and neither of the virtual machines have sufficient available processor resources to handle an additional request 82A. While virtual machines 31A and 31B are receiving and processing requests 82A, auto-scaling group manager 34 detects that the maximum threshold for virtual machine 31A has been reached, and uses the virtual machine configuration for auto-scaling group 36A to create and deploy virtual machine 31C. As shown in FIG. 4, virtual machine 31C has sufficient processor resources to handle an additional series of requests 82A.

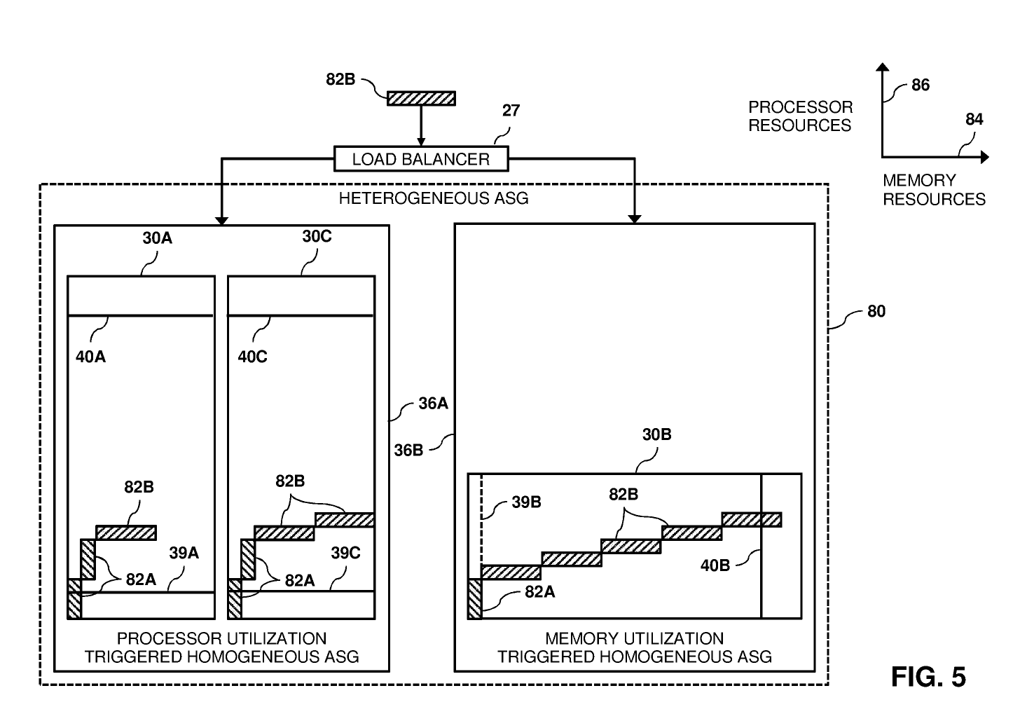

While FIGS. 3 and 4 show heterogeneous auto-scaling group 80 processing requests 82A, the types of requests 82 that the heterogeneous auto-scaling group may vary. For example, heterogeneous auto-scaling group 80 may initially process requests 82A for an online retailer, where requests 82A comprise orders that are processor intensive. If the online retailer launches a marketing campaign for an item whose order generates request 82B (i.e., the request is memory intensive), load balancer 30 may start receiving a series of requests 82B, as shown in FIG. 5.

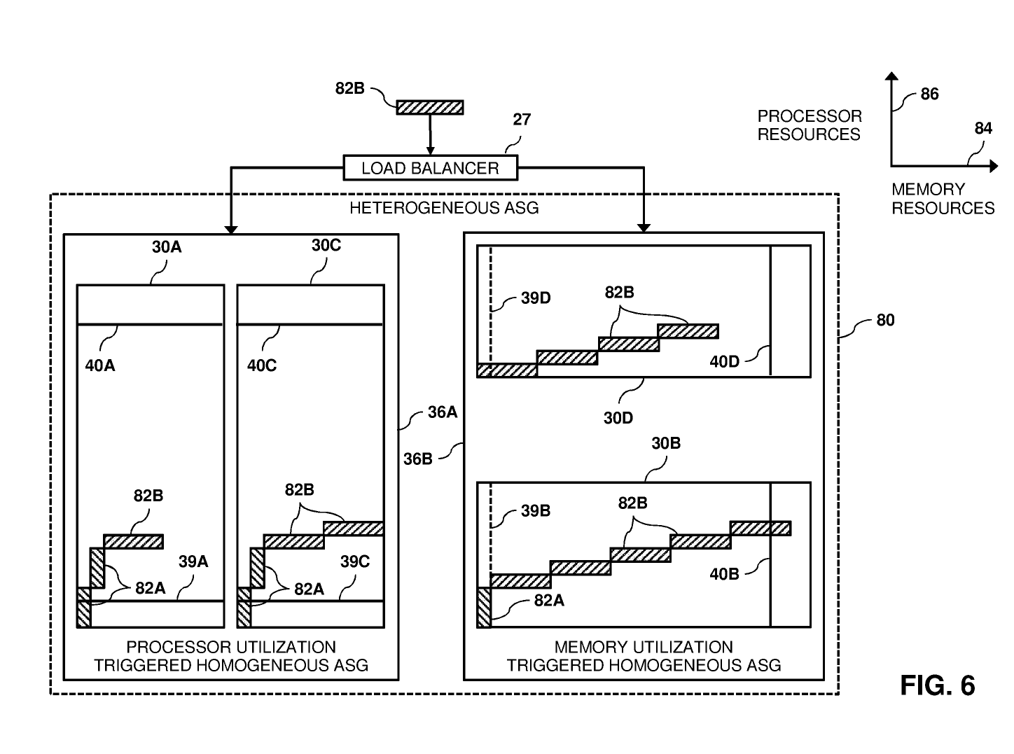

In the example shown in FIG. 5, neither of the virtual machines have memory resources that are available to handle an additional request 82B. While virtual machines 31A, 31B are receiving requests 82B and processing requests 82A and 82B, auto-scaling group manager 34 detects that the maximum memory threshold for virtual machine 31B has been reached, and uses the virtual machine configuration for auto-scaling group 36B to create and deploy virtual machine 31D. As shown in FIG. 6, virtual machine 3D has sufficient memory resources to handle an additional series of requests 82B.

While examples of processing systems described supra include physical computer systems, virtual machines 31 and software containers, other types of processing systems that can be used in auto-scaling group 36 are considered to be within the spirit and scope of the present invention. Additionally, while examples of monitored resources 38 described supra include respective utilizations of processors 32, respective utilizations of memories 33, and I/O utilization, configuring auto-scaling group manager 34 to monitor any other type of system resource in facility 20 is considered to be within the spirit and scope of the present invention.

The flowchart(s) and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method, comprising:
defining, for a request processing system, a first homogeneous auto-scaling group comprising a first monitored resource, a first set of processing systems, a first minimum threshold, a first maximum threshold, and a first system configuration;
defining, for the request processing system, a second homogeneous auto-scaling group comprising a second monitored resource different from the first monitored resource, a second set of processing systems, a second minimum threshold, a second maximum threshold, and a second system configuration different from the first system configuration; and
managing, by a load balancer for the request processing system, the first and the second sets of processing systems.

2. The method according to claim 1 wherein each of the first and the second monitored resources is selected from a group consisting of a processor utilization level, an input/output utilization level and a memory utilization level.

3. The method according to claim 1, wherein each of the processing systems is selected from a group consisting of a physical computing system, a virtual machine and a software container.

4. The method according to claim 1, wherein the heterogeneous auto-scaling group comprises a set of processing systems, wherein at least one of the processing systems is configured using the first system configuration, and wherein at least one of the processing systems is configured using the second system configuration.

5. The method according to claim 4, wherein managing the first and the second sets of processing systems comprises receiving a request, and conveying the request to a given processing system in the first and the second sets.

6. An apparatus, comprising:
a memory; and
a processor configured:
to define, in the memory, a first homogeneous auto-scaling group comprising a first monitored resource, a first set of processing systems, a first minimum threshold, a first maximum threshold, and a first system configuration,
to define, in the memory, a second homogeneous auto-scaling group comprising a second monitored resource different from the first monitored resource, a second minimum threshold, a second set of processing systems, a second maximum threshold, and a second system configuration different from the first system configuration, and
to manage the first and the second sets of processing systems.

7. The apparatus according to claim 6 wherein each of the first and the second monitored resources is selected from a group consisting of a processor utilization level, an input/output utilization level and a memory utilization level.

8. The apparatus according to claim 6, wherein each of the processing systems is selected from a group consisting of a physical computing system, a virtual machine and a software container.

9. The apparatus according to claim 6, wherein the heterogeneous scaling group comprises a set of processing systems, wherein at least one of the processing systems is configured using the first system configuration, and wherein at least one of the processing systems is configured using the second system configuration.

10. The apparatus according to claim 9, wherein the processor is configured to manage the first and the second sets of processing systems by receiving a request, and conveying the request to a given processing system in the first and the second sets.

11. The apparatus according to claim 6, wherein the processor comprises a first processor, wherein the memory comprises a first memory, and further comprising a second processor, wherein the first processor is configured to define the first and the second homogeneous auto-scaling groups, and wherein the second processor is configured to manage the first and the second sets of processing systems.

12. A computer program product, the computer program product comprising:
a non-transitory computer readable storage medium having computer readable program code embodied therewith, the computer readable program code comprising:
computer readable program code configured to define, for a request processing system, a first homogeneous auto-scaling group comprising a first monitored resource, a first set of processing systems, a first minimum threshold, a first maximum threshold, and a first system configuration;
computer readable program code configured to define, for the request processing system, a second homogeneous auto-scaling group comprising a second monitored resource different from the first monitored resource, a second set of processing systems, a second minimum threshold, a second maximum threshold, and a second system configuration different from the first system configuration; and
computer readable program code configured to manage, by a load balancer for the request processing system, the first and the second sets of processing systems.

13. The computer program product according to claim 14 wherein each of the first and the second monitored resources is selected from a group consisting of a processor utilization level, an input/output utilization level and a memory utilization level.

14. The computer program product according to claim 12, wherein each of the processing systems is selected from a group consisting of a physical computing system, a virtual machine and a software container.

15. The computer program product according to claim 12, wherein the heterogeneous auto-scaling group comprises a set of processing systems, wherein at least one of the processing systems is configured using the first system configuration, and wherein at least one of the processing systems is configured using the second system configuration.

16. The computer program product according to claim 15, wherein the computer readable program code is configured to manage the first and the second sets of processing systems by receiving a request, and conveying the request to a given processing system in the first and the second sets.
